(19) United States
(12) Patent Application Publication
(10) Pub. No.: US 2025/0010601 A1
(43) Pub. Date: Jan. 9, 2025

(54) WOOD GRAIN TRANSFER PROCESS FOR HEIGHT-ADJUSTABLE TABLES

(71) Applicant: Ningbo Yaoze Intelligent Technology Co., Ltd, Ningbo (CN)

(72) Inventors: Qingliang Zhang, Ningbo (CN); Hao Xie, Ningbo (CN)

(21) Appl. No.: 18/504,565

(22) Filed: Nov. 8, 2023

(30) Foreign Application Priority Data
Jul. 3, 2023 (CN) 2023108044736

(51) Int. Cl. B32B 37/00; B41M 5/382

(52) U.S. Cl. CPC B32B 37/025; B32B 38/162; B32B 38/164; B32B 2309/02; B32B 2309/04; B32B 2309/12

(57) ABSTRACT

A wood grain transfer process for height-adjustable tables comprises the following steps: S1. selecting pre-coated metal components to be processed; S2. attaching the front side of the wood grain thermal transfer paper to the metal components' transfer surface using thermal transfer adhesive, enabling the wood grain thermal transfer paper to be tightly attached to the transfer surface of the metal part to be transferred; S3. baking the wrapped metal components in the oven, and appropriately adjusting the temperature and baking time according to the metal components' characteristics, the texture's depth, and specific oven performance. By significantly improving the service life and use effect of the product, the coating surface hardness of the coating can reach 6 to 9 hours, and the photocatalytic material can produce antibacterial, deodorizing, oil decomposition, mildew proofing, algae proofing, and air purifying effects under irradiation of sunlight or indoor fluorescent lamps.

### 1. TECHNICAL FIELD

The invention relates to the field of thermal transfer printing technology, in particular to a wood grain transfer process for height-adjustable tables.

### 2. BACKGROUND ART

With the development of the times and the improvement of living standards, people's requirements for furniture are also getting increasingly higher. Therefore, the usage rates of wood and stone materials are also becoming very high. The main reason is that people prefer for wood and stone textures. Since wood and stone materials, themselves have wood and stone textures, their usage and application amount are very high. However, the high usage rate also leads to excessive collection of wood and stone materials. At the same time, due to the expensive processing of wood and stone materials and their natural textures, it is impossible to modify their textures. Therefore, it is also difficult to satisfy corresponding customers. The unique wood and stone textures also make some wood and stone materials very expensive, making them inaccessible to ordinary users.

There are two types of wood grain transfer technology: water transfer printing focusing on characters, photos and graphics, and water transfer printing with curved surface overspread method for complete transfer printing over the entire surface of a product.

Height-adjustable table components usually comprise: height-adjustable table motors and controllers, which are key components for the height-adjustable table to rise and fall. The height-adjustable table controller can manually or automatically adjust the motor speed and height. Some high-end height-adjustable table controllers can also provide memory and timing functions; supporting columns or stand columns, which are the main structural elements of the height-adjustable table, to connect the tabletop and base and withstand the weight of the tabletop and items; links, which can transfer the motion of the lift motor to the tabletop when the height-adjustable table rises or lowers; locating pins, which are used to ensure the tabletop is always level for some height-adjustable tables; slides, which are usually installed on the columns so that the tabletop can move horizontally, allowing the tabletop to comfortably accommodate different body types and user needs; handles or buttons, which are used to manually control the height-adjustable table; junction box and wires, which deliver power to the height-adjustable table motors and controllers to ensure they operate properly.

The hardness of ordinary spray-coated height-adjustable table components can only reach 3H, without self-cleaning. Ordinary products tend to be not high-temperature resistant during a fire and are extremely prone to generating thick smoke. In order to better improve the hardness of the spray coating on the product surface and enhance the self-cleaning function of the product itself, providing high temperature resistance of the product, the invention adopts a wood grain transfer process for height-adjustable tables.

### 3. SUMMARY OF THE INVENTION

In view of the deficiencies of the prior art, the invention provides a process of spraying technology and vacuum wood grain transfer technology, involving spraying process and vacuum wood grain transfer technology, which solves the following problems: the hardness of ordinary spray plastic processes for height-adjustable table components can only reach 3H, height-adjustable table components cannot self-clean, and ordinary products are not high-temperature resistant during a fire and are extremely prone to generating thick smoke.

In order to achieve the above purpose, the invention has the following technical solutions: a wood grain transfer process for height-adjustable tables comprises vacuum wood grain transfer process and adhesive transfer process, and the vacuum wood grain transfer process uses the following raw materials: degreasing solution, passivation solution, pure water, mixed powder of spraying thermosetting powder coating plus photocatalyst, wood grain paper and heat-resistant plastic bag; and the adhesive transfer process uses the following raw materials: degreasing solution, passivation solution, pure water, mixed powder of spraying thermosetting powder coating plus photocatalyst, thermal transfer adhesive and wood grain paper.

Preferably, the adhesive transfer process, according to the wood grain transfer process for height-adjustable tables as claimed in claim 1, wherein comprises the following steps:
S1: selecting the coated metal components of height-adjustable table to be processed;
S2: adhering the front side of the wood grain thermal transfer paper to the transfer surface of the metal component to be transferred by using thermal transfer adhesive; the purpose of using thermal transfer adhesive is to make the wood grain thermal transfer paper attach tightly to the transfer surface of the metal component to be transferred.
S3: sending the wrapped metal components into the baking oven for baking, and properly adjusting the temperature and time of baking according to factors, such as the characteristics of the metal parts to be transferred, the depth of the texture to be transferred, and the specific performance of the baking oven;
S4: taking out the transferred metal parts from the oven and pulling off the plastic tapes from one end of the transferred metal parts; tearing off the transfer paper and cleaning the surface.

Preferably, the vacuum wood grain transfer process for height-adjustable tables, according to the wood grain transfer process for height-adjustable tables as claimed in claim 1, wherein comprises the following steps:
S1: selecting the coated metal components of height-adjustable table to be processed;
S2: wrapping the metal parts to be transferred with wood grain transfer paper, and fixing the interfaces of the paper with heat-resistant adhesive tape to prevent the wood grain transfer paper from coming loose;
S3: putting on heat-resistant and well-sealed tubular plastic bags over the metal components wrapped with wood grain transfer paper, then vacuuming both ends of the plastic bags until the plastic bags can be fully and effectively attached to the metal components; properly adjusting the magnitude of the negative pressure of the vacuum according to factors, such as the characteristics of the metal parts to be transferred and the negative pressure the plastic tapes can withstand, enabling the negative pressure between 0.3 to 0.8 MPa;
S4: sending the wrapped metal components into the baking oven for baking, and properly adjusting the temperature and time of baking according to factors, such as the characteristics of the metal parts to be transferred, the depth of the texture to be transferred, and the specific performance of the baking oven;
S5: taking out the transferred metal parts from the oven and pulling off the plastic tapes from one end of the transferred metal parts; tearing off the transfer paper and cleaning the surface.

Preferably, the mixed powder of spraying thermosetting powder coating plus photocatalyst comprises the following raw materials: 99% of spraying thermosetting powder coating, 1% of photocatalyst; the spraying thermosetting powder coating comprises the following raw materials: epoxy resin, polyester, filler, additives and pigments, and the photocatalyst mainly comprises titanium dioxide.

Preferably, the mixed powder of spraying thermosetting powder coating plus photocatalyst comprises the following preparation steps:
I. mixing the epoxy resin, polyester, filler, additives and pigments evenly in a certain proportion, and obtaining the spraying thermosetting powder coating after mixing uniformly by a constant speed mechanical stirrer;
II. placing the spraying thermosetting powder coating and titanium dioxide together in a stirrer and stirring at 120 to 150 rpm for 8 to 10 minutes to finally obtain the mixed powder of spraying thermosetting powder coating plus photocatalyst.

Preferably, the thermal transfer adhesive adopted in the adhesive transfer process is water-based, and the ratio of adhesive to water is 1:4.

Preferably, in step II, the ball mill is operated at a ball milling speed of 300 to 320 rpm.

Preferably, in step II, the dried powder is sieved through a 200 to 250 mesh sieve for screening.

Preferably, in S3, the transfer temperature is 180 to 200° C., and the duration time is 15 to 20 minutes.

Preferably, in S4, the transfer temperature is typically 180 to 200° C., and the duration time is 15 to 20 minutes.

The invention provides a wood grain transfer process for height-adjustable tables and has the following beneficial effects:
1. The coating obtained by the above process makes the product have good coating hardness, gloss, impact resistance, adhesion, stain resistance, acid resistance, alkali resistance, oil resistance, detergent resistance, scrubbing resistance, boiling water resistance and fire protection performance and many other properties, making the product has multiple functional attributes to adapt to various environmental impacts, which greatly improves the service life and usage effect of the product. The surface coating hardness of the coating can reach 6-9H, and the composition of the coating determines that the product can withstand high temperatures up to 1500° C. and is fire-proof suitable for use in enclosed spaces, which does not produce thick smoke in case of fire.
2. The photocatalytic material obtained by the invention is a material that does not change by itself under light irradiation, but can promote chemical reactions, which utilizes the light energy existing in nature to convert into the energy required for chemical reactions to produce a catalytic effect, and the surrounding oxygen and water molecules are excited into highly oxidizing free anions. The photocatalytic material does not change by itself under light irradiation, but can promote chemical reactions, which resembles the chlorophyll in plants' photosynthesis. Under the irradiation of sunlight or indoor fluorescent lamps, photocatalytic materials can have multiple effects, including antibacterial, deodorizing, oil decomposition, mildew prevention and algae prevention, and air purification effects.
3. In the invention, the front side of the wood grain thermal transfer paper is adhered to the transfer surface of the metal component to be transferred by using thermal transfer adhesive. The purpose of using thermal transfer adhesive is to make the wood grain thermal transfer paper attach tightly to the transfer surface of the metal component to be transferred. The wrapped metal components are sent to the oven for baking, and the temperature and time of baking should be appropriately adjusted according to the characteristics of the metal component to be transferred, the depth of the texture to be transferred and the specific performance of the oven. According to the principle of high temperature sublimation thermal penetration, through heating and pressing, the wood grain pattern on the transfer paper or transfer film is quickly transferred and penetrated onto the sprayed workpiece, so that the produced wood grain profiles have clear textures, strong stereo sense, and better reflect the natural feel of the wood grain.

### 4. BRIEF DESCRIPTION OF ACCOMPANY DRAWINGS

FIG. 1 is a schematic diagram showing the wood grain transfer process for height-adjustable tables of the invention;

FIG. 2 is an overall process flow chart of the invention.

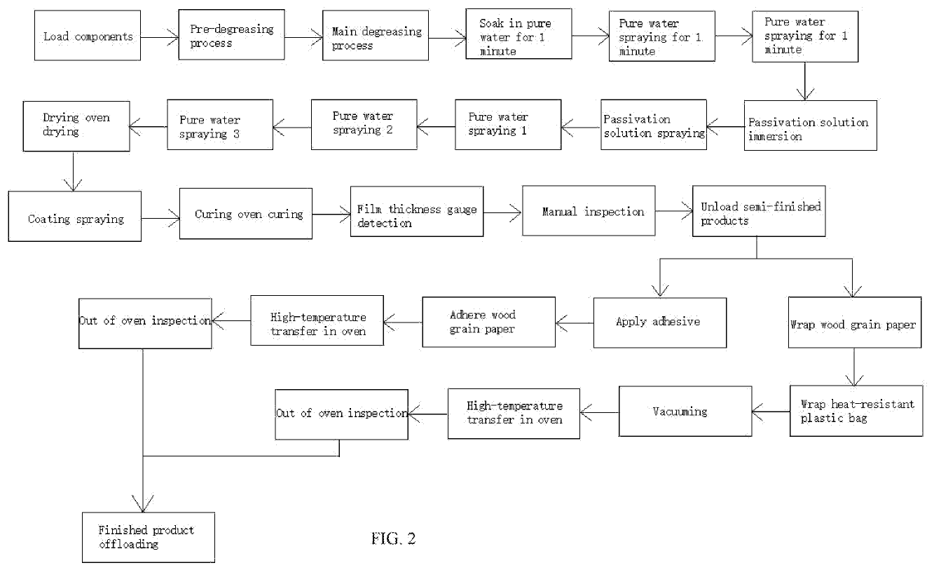

### 5. SPECIFIC EMBODIMENT OF THE INVENTION

To make the technical solutions provided by the invention more comprehensible, a further description of the invention is given below in combination with the attached drawings and embodiments, and the embodiments are exemplary and not the limitations of the scope of the disclosure. Apparently, the described drawings are merely some embodiments of the application rather than all the embodiments of the application. It should be understood that the application is not limited to the drawings described herein. Based on the drawings in the invention, all other drawings obtained by those of ordinary skill in the art without making creative labor fall within the scope of protection of the invention.

### Embodiment 1

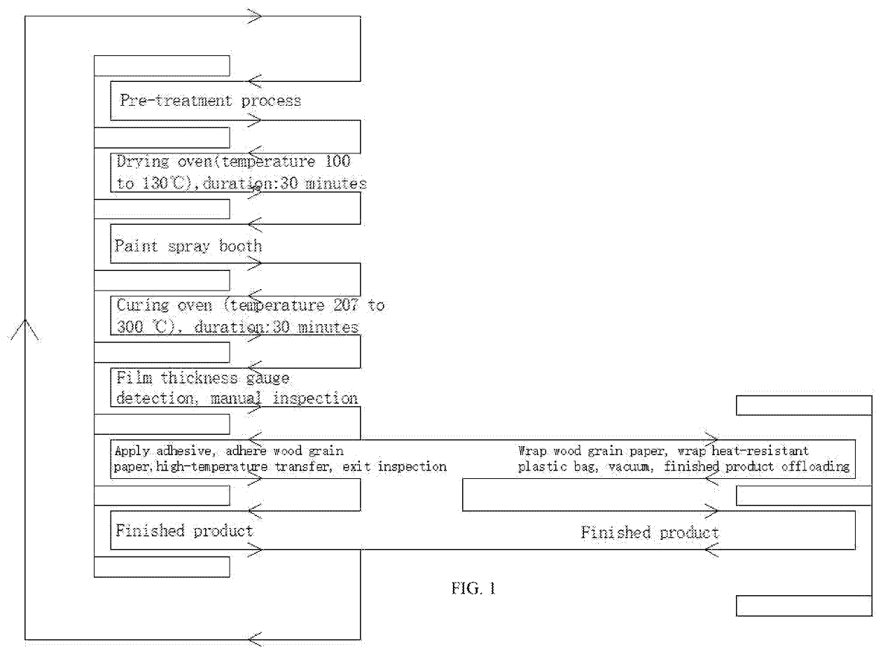

Referring to the FIG. 1, the embodiment of the invention provides the wood grain transfer process for height-adjustable tables, which comprises vacuum wood grain transfer process and adhesive transfer process. The vacuum wood grain transfer process uses the following raw materials: degreasing solution, passivation solution, pure water, mixed powder of spraying thermosetting powder coating plus photocatalyst, wood grain paper and heat-resistant plastic bag; and the adhesive transfer process uses the following raw materials: degreasing solution, passivation solution, pure water, mixed powder of spraying thermosetting powder coating plus photocatalyst, thermal transfer adhesive and wood grain paper.

The mixed powder of spraying thermosetting powder coating plus photocatalyst comprises the following raw materials: 99% of spraying thermosetting powder coating, 1% of photocatalyst; the spraying thermosetting powder coating comprises the following raw materials: epoxy resin, polyester, filler, additives and pigments, and the photocatalyst mainly comprises titanium dioxide.

The mixed powder of spraying thermosetting powder coating plus photocatalyst comprises the following preparation steps:
I. mixing the epoxy resin, polyester, filler, additives and pigments evenly in a certain proportion, and obtaining the spraying thermosetting powder coating after mixing uniformly by a constant speed mechanical stirrer;
II. placing the spraying thermosetting powder coating and titanium dioxide together in a stirrer and stirring at 120 rpm for 8 minutes to finally obtain the mixed powder of spraying thermosetting powder coating plus photocatalyst.

Titanium dioxide nanoparticles are compounds of titanium and oxygen, which are chemically stable, safe and environmentally friendly substances, and often used as cosmetic and food additives. Titanium dioxide nanoparticles use light as energy to generate active oxygen from oxygen in air and water. Through chemical reactions, it decomposes, deodorizes and detoxifies harmful substances. Furthermore, titanium dioxide also has the effect of absorbing ultraviolet rays, making it a high-functional and environmental purification substance. Due to the very high refractive index of light, titanium dioxide may actually look a little hazy, and the titanium dioxide nanoparticles contained in the photocatalyst react with water vapor in the air under sunlight irradiation to generate active oxygen. Such active oxygen decomposes harmful substances and weakens the adhesion of dirt and can decompose odors from cigarettes and pets as well as harmful gases such as formaldehyde that cause sick building syndrome by coating on walls and ceilings. The titanium dioxide nanoparticles contained in the photocatalyst have a significant barrier effect on ultraviolet rays, preventing fading and increasing the durability of exterior walls. In addition, due to its high transparency, it does not damage the beautiful colors of wall materials.

In addition, titanium dioxide nanoparticles that utilize the ultraviolet rays in sunlight and light from illumination lamps are an environmentally friendly substance, safe and non-toxic. JP-ECO photocatalyst is a new visible light photocatalyst researched by Japan Ecosystem Corporation, which is effective in removing aldehydes, antibacterial and mildew prevention, and is recognized as an air purification product.

The photocatalytic material obtained by this process is a material that does not change by itself under light irradiation but can promote chemical reactions. More specifically, the material utilizes the light energy existing in nature to convert into the energy required for chemical reactions to produce a catalytic effect, and the surrounding oxygen and water molecules are excited into highly oxidizing free anions. The photocatalytic material does not change by itself under light irradiation, but can promote chemical reactions, which resembles the chlorophyll in plants' photosynthesis. Under the irradiation of sunlight or indoor fluorescent lamps, photocatalytic materials can have multiple effects, including produce antibacterial, deodorizing, oil decomposition, mildew prevention and algae prevention, and air purification effects. Photocatalysis is a synthetic word for prefix photo- and catalyst. The photocatalytic material is a material that does not change by itself under light irradiation, but can promote chemical reactions, which utilizes the light energy existing in nature to convert into the energy required for chemical reactions to produce a catalytic effect, exciting the surrounding oxygen and water molecules into highly oxidizing free anions. The photocatalytic material can decompose almost all organic and some inorganic substances that are harmful to humans and the environment. In addition to accelerate reactions, such materials can also utilize the laws of nature without causing waste of resources and additional pollution. At present, photocatalytic materials are mainly titanium dioxide.

The embodiment of the invention provides the adhesive transfer process in the wood grain transfer process for height-adjustable tables, which comprises the following steps:
S1: manually hanging the height-adjustable table metal components to be processed on the hooks of the circular production line; spraying the metal components with 1:100 degreasing solution for 3 minutes, and then soaking in pure water for 2 minutes; processing the spraying step for 3 times, with 3 minutes each time; soaking in 2:100 passivation solution for 3 minutes after spraying with pure water, and rinsing with pure water spray for 3 times after spraying the passivation solution for 2 minutes, 2 minutes for each time;
S2: the metal components entering into a water-drying oven after rinsing with pure water spraying for 3 times, and drying at a temperature of 130° C. for 30 minutes; the dried metal components entering into the paint spray booth with 5 spray guns on each side for spraying and coating, with a mixed powder of spraying thermosetting powder coating plus photocatalyst in the spray gun;
S3: the dried metal components entering the curing oven for powder curing and shaping at a high temperature of 300° C.; after detection by a film thickness gauge, selecting the metal components with the thickness maintained at 50 um as the standard components; the qualified components entering into the manual inspection line for manual inspection of the coating effect, to select the coated metal components for semi-finished products;
S4: S4: wrapping the metal parts to be transferred with wood grain transfer paper, and fixing the interfaces of the paper with heat-resistant adhesive tape to prevent the wood grain transfer paper from coming loose; then putting on heat-resistant and well-sealed tubular plastic bags over the metal components wrapped with wood grain transfer paper, then vacuuming both ends of the plastic bags until the plastic bags can be fully and effectively attached to the metal components; sending the wrapped metal components into the baking oven for baking at 200° C. for 20 minutes; taking out the transferred metal components from the oven, tearing off the thermal transfer paper, and carrying out oven examination and semi-finished product processing.

Referring to the FIG. 1, the embodiment of the invention provides the vacuum wood grain transfer process for height-adjustable tables in the wood grain transfer process for height-adjustable tables, which comprises the following steps:
S1: selecting the coated metal components of height-adjustable table to be processed;
S2: adhering the front side of the wood grain thermal transfer paper to the transfer surface of the metal component to be transferred by using thermal transfer adhesive; the purpose of using thermal transfer adhesive is to make the wood grain thermal transfer paper attach tightly to the transfer surface of the metal component to be transferred.
S3: sending the wrapped metal components into the baking oven for baking, and properly adjusting the temperature and time of baking according to factors, such as the characteristics of the metal parts to be transferred, the depth of the texture to be transferred, and the specific performance of the baking oven;
S4: taking out the transferred metal parts from the oven and pulling off the plastic tapes from one end of the transferred metal parts; tearing off the transfer paper and cleaning the surface.

### Embodiment 2

The embodiment of the invention provides the wood grain transfer process for height-adjustable tables, wherein comprises vacuum wood grain transfer process and adhesive transfer process, and the vacuum wood grain transfer process uses the following raw materials: degreasing solution, passivation solution, pure water, mixed powder of spraying thermosetting powder coating plus photocatalyst, wood grain paper and heat-resistant plastic bag; and the adhesive transfer process uses the following raw materials: degreasing solution, passivation solution, pure water, mixed powder of spraying thermosetting powder coating plus photocatalyst, thermal transfer adhesive and wood grain paper.

The mixed powder of spraying thermosetting powder coating plus photocatalyst comprises the following raw materials: 99% of spraying thermosetting powder coating, 1% of photocatalyst; the spraying thermosetting powder coating comprises the following raw materials: epoxy resin, polyester, filler, additives and pigments, and the photocatalyst mainly comprises titanium dioxide.

The mixed powder of spraying thermosetting powder coating plus photocatalyst comprises the following preparation steps:
I. mixing the epoxy resin, polyester, filler, additives and pigments evenly in a certain proportion, and obtaining the spraying thermosetting powder coating after mixing uniformly by a constant speed mechanical stirrer;
II. placing the spraying thermosetting powder coating and titanium dioxide together in a stirrer and stirring at 150 rpm for 10 minutes to finally obtain the mixed powder of spraying thermosetting powder coating plus photocatalyst.

The photocatalytic material obtained by this process is a material that does not change by itself under light irradiation but can promote chemical reactions. More specifically, the material utilizes the light energy existing in nature to convert into the energy required for chemical reactions to produce a catalytic effect, and the surrounding oxygen and water molecules are excited into highly oxidizing free anions. The photocatalytic material does not change by itself under light irradiation, but can promote chemical reactions, which resembles the chlorophyll in plants' photosynthesis. Under the irradiation of sunlight or indoor fluorescent lamps, photocatalytic materials can have multiple effects, including produce antibacterial, deodorizing, oil decomposition, mildew prevention and algae prevention, and air purification effects.

The embodiment of the invention provides the adhesive transfer process in the wood grain transfer process for height-adjustable tables, which comprises the following steps:
S1: manually hanging the height-adjustable table metal components to be processed on the hooks of the circular production line; spraying the metal components with 1:100 degreasing solution for 2 minutes, and then soaking in pure water for 1 minute; processing the spraying step for 2 times, with 1 minute each time; soaking in 2:100 passivation solution for 3 minutes after spraying with pure water, and rinsing with pure water spray for 2 times after spraying the passivation solution for 1 minute, 1 minute for each time;
S2: the metal components entering into a water-drying oven after rinsing with pure water spraying for 2 to 3 times, and drying at a temperature of 100° C. for 30 minutes; the dried metal components entering into the paint spray booth with 3 spray guns on each side for spraying and coating, with a mixed powder of spraying thermosetting powder coating plus photocatalyst in the spray gun;
S3: the dried metal components entering the curing oven for powder curing and shaping at a high temperature of 270° C.; after detection by a film thickness gauge, selecting the metal components with the thickness maintained at 30 um as the standard components; the qualified components entering into the manual inspection line for manual inspection of the coating effect, to select the coated metal components for semi-finished products;
S4: wrapping the metal parts to be transferred with wood grain transfer paper, and fixing the interfaces of the paper with heat-resistant adhesive tape to prevent the wood grain transfer paper from coming loose; then putting on heat-resistant and well-sealed tubular plastic bags over the metal components wrapped with wood grain transfer paper, then vacuuming both ends of the plastic bags until the plastic bags can be fully and effectively attached to the metal components; sending the wrapped metal components into the baking oven for baking at 185° C. for 15 minutes; taking out the transferred metal components from the oven, tearing off the thermal transfer paper, and carrying out oven examination and semi-finished product processing.

The embodiment of the invention provides the adhesive transfer process, according to the wood grain transfer process for height-adjustable tables as claimed in claim 1, which comprises the following steps:
S1: manually hanging the height-adjustable table metal components to be processed on the hooks of the circular production line; spraying the metal components with 1:100 degreasing solution for 2 minutes, and then soaking in pure water for 1 minute; processing the spraying step for 2 times, with 1 minute each time; soaking in 2:100 passivation solution for 3 minutes after spraying with pure water, and rinsing with pure water spray for 2 times after spraying the passivation solution for 1 minute, 1 minute for each time;
S2: the metal components entering into a water-drying oven after rinsing with pure water spraying for 2 times, and drying at a temperature of 100° C. for 30 minutes; the dried metal components entering into the paint spray booth with 3 spray guns on each side for spraying and coating, with a mixed powder of spraying thermosetting powder coating plus photocatalyst in the spray gun;
S3: the dried metal components entering the curing oven for powder curing and shaping at a high temperature of 270° C.; after detection by a film thickness gauge, selecting the metal components with the thickness maintained at 30 um as the standard components; the qualified components entering into the manual inspection line for manual inspection of the coating effect, to select the coated metal components for semi-finished products;
S4: coating the metal components with thermal transfer adhesive, which is water-based and the ratio of adhesive to water is 1:4; attaching the front side of the wood grain thermal transfer paper to the transfer surface of the metal part using thermal transfer adhesive, and pasting the wood grain paper; sending the wrapped metal components into the baking oven for baking at 185° C. for 15 minutes; taking out the transferred metal components from the oven, tearing off the thermal transfer paper, and carrying out oven examination and semi-finished product processing.

The coating formed by the above process enables the product to withstand high temperatures up to 1500° C. and be fireproof for use in enclosed spaces without producing thick smoke in case of fire.

The coating inspection standards for workpieces are as follows:

| No. | Inspection Item | | Inspection Method | Technical Standard |
|---|---|---|---|---|
| 1 | Appearance | | Visual Inspection | The surface is flat and |
| | | | | smooth without |
| | | | | scratches, flow marks, |
| | | | | cracks, bubbles, |
| | | | | impurities or other |
| | | | | obvious defects |
| 2 | Thickness | | Thickness Gauge | Average 30 um |
| 3 | Color difference | | MINOLTA Color | Color difference ΔE < 2 |
| | | | Difference Analyzer | for solid color |
| 4 | Coating hardness | | Pencil Hardness Tester | 7H to 9H |
| 5 | Gloss | | Gloss Meter | Gloss degree 40 to 60, |
| | | | | error < 2 |
| 6 | Impact resistance | | Ball Impact Test | 50KG.CM impact |
| | | | | without cracks, no paint |
| | | | | falling off |
| 7 | Adhesion | | Cross-Cut Test (Dry) | Grade 0 (no paint falling |
| | | | | off) |
| 8 | Stain resistance | | 1 Hour Immersion in | No change to surface |
| | | | Carbon Black Water at | after wiping with alcohol |
| | | | 80° C. | |
| 9 | Chemical | Acid | 5% Hydrochloric Acid | No change to surface |
| | resistance | resistance | Solution for 24 Hours | |
| | | Alkali | 5% Sodium Hydroxide | No change to surface |
| | | resistance | for 24 Hours | |
| | | Oil | Oil Stain for 24 Hours | No change to surface |
| | | resistance | | |
| | | Detergent | Detergent for 24 Hours | No change to surface |
| | | resistance | | |

| 10 | Scrub resistance | >10,000 Times Surface | No change |
|---|---|---|---|
| | | Wiping | |
| 11 | Boiling water resistance | 2 Hours in 90° C. ± 2° C. | No change |
| | | Boiling Water | |
| 12 | Fire protection | GB 8624-2006 Test | Grade A1 |
| | performance | | |

In conclusion, the coating obtained by the above process makes the product have good coating hardness, gloss, impact resistance, adhesion, stain resistance, acid resistance, alkali resistance, oil resistance, detergent resistance, scrubbing resistance, boiling water resistance and fire protection performance and many other properties, making the product has multiple functional attributes to adapt to various environmental impacts, which greatly improves the service life and usage effect of the product.

Although embodiments of the invention have been shown and described, it will be understood by those of ordinary skill in the art that a variety of variations, modifications, replacements and variants of these embodiments can be made without departing from the principles and spirit of the invention. Therefore, the protection scope of the invention should be subject to the protection scope defined by the claims and equivalents thereof.

1. A wood grain transfer process for height-adjustable tables, wherein comprises a vacuum wood grain transfer process and adhesive transfer process, and the vacuum wood grain transfer process uses the following raw materials: degreasing solution, passivation solution, pure water, mixed powder of spraying thermosetting powder coating plus photocatalyst, wood grain paper and heat-resistant plastic bag; and the adhesive transfer process uses the following raw materials: degreasing solution, passivation solution, pure water, mixed powder of spraying thermosetting powder coating plus photocatalyst, thermal transfer adhesive and wood grain paper.

2. An adhesive transfer process, according to the wood grain transfer process for height-adjustable tables as claimed in claim 1, wherein comprises the following steps:
S1: manually hanging the height-adjustable table metal components to be processed on the hooks of the circular production line; spraying the metal components with 1:100 degreasing solution for 1 to 2 minutes, and then soaking in pure water for 1 to 2 minutes; processing the spraying step for 2 to 3 times, with 1 to 3 minutes each time; soaking in 2:100 passivation solution for 1 to 3 minutes after spraying with pure water, and rinsing with pure water spray for 2 to 3 times after spraying the passivation solution for 1 to 3 minutes, 1 to 3 minutes for each time;
S2: the metal components entering into a water-drying oven after rinsing with pure water spraying for 2 to 3 times, and drying at a temperature of 100 to 120° C. for 20 to 30 minutes; the dried metal components entering into the paint spray booth with 2 to 3 spray guns on each side for spraying and coating, with a mixed powder of spraying thermosetting powder coating plus photocatalyst in the spray gun;
S3: the dried metal components entering the curing oven for powder curing and shaping at a high temperature of 200 to 270° C.; after detection by a film thickness gauge, selecting the metal components with the thickness maintained at 20 to 30 um as the standard components; the qualified components entering into the manual inspection line for manual inspection of the coating effect, to select the coated metal components for semi-finished products;
S4: coating the metal components with thermal transfer adhesive, which is water-based and the ratio of adhesive to water is 1:4; attaching the front side of the wood grain thermal transfer paper to the transfer surface of the metal part using thermal transfer adhesive, and pasting the wood grain paper; sending the wrapped metal components into the baking oven for baking at 185 to 200° C. for 10 to 15 minutes; taking out the transferred metal components from the oven, tearing off the thermal transfer paper, and carrying out oven examination and semi-finished product processing.

3. A vacuum wood grain transfer process for height-adjustable tables, according to the wood grain transfer process for height-adjustable tables as claimed in claim 1, wherein comprises the following steps:
S1: selecting the coated metal components of height-adjustable table to be processed;
S2: wrapping the metal parts to be transferred with wood grain transfer paper, and fixing the interfaces of the paper with heat-resistant adhesive tape to prevent the wood grain transfer paper from coming loose;
S3: putting on heat-resistant and well-sealed tubular plastic bags over the metal components wrapped with wood grain transfer paper, then vacuuming both ends of the plastic bags until the plastic bags can be fully and effectively attached to the metal components; properly adjusting the magnitude of the negative pressure of the vacuum according to factors, such as the characteristics of the metal parts to be transferred and the negative pressure the plastic tapes can withstand, enabling the negative pressure between 0.3 to 0.8 MPa;
S4: sending the wrapped metal components into the baking oven for baking, and properly adjusting the temperature and time of baking according to factors, such as the characteristics of the metal parts to be transferred, the depth of the texture to be transferred, and the specific performance of the baking oven;
S5: taking out the transferred metal parts from the oven and pulling off the plastic tapes from one end of the transferred metal parts; tearing off the transfer paper, and cleaning the surface.

4. The wood grain transfer process for height-adjustable tables as claimed in claim 1, wherein the mixed powder of spraying thermosetting powder coating plus photocatalyst comprises the following raw materials: 99% of spraying thermosetting powder coating, 1% of photocatalyst; the spraying thermosetting powder coating comprises the following raw materials: epoxy resin, polyester, filler, additives and pigments, and the photocatalyst mainly comprises titanium dioxide.

5. The wood grain transfer process for height-adjustable tables as claimed in claim 1, wherein the mixed powder of spraying thermosetting powder coating plus photocatalyst comprises the following preparation steps:
I. mixing the epoxy resin, polyester, filler, additives and pigments evenly in a particular proportion, and obtaining the spraying thermosetting powder coating after mixing uniformly by a constant speed mechanical stirrer;
II. placing the spraying thermosetting powder coating and titanium dioxide together in a stirrer and stirring at 120 to 150 rpm for 8 to 10 minutes to finally obtain the mixed powder of spraying thermosetting powder coating plus photocatalyst.

6. The adhesive transfer process as claimed in claim 2, wherein the thermal transfer adhesive adopted in the adhesive transfer process is water-based, and the ratio of adhesive to water is 1:4.

7. The wood grain transfer process for height-adjustable tables as claimed in claim 5, wherein in step II, the ball mill is operated at a ball milling speed of 300 to 320 rpm (revolutions per minute).

8. The wood grain transfer process for height-adjustable tables as claimed in claim 5, wherein in step II, the dried powder is sieved through a 200 to 250 mesh sieve for screening.

9. The adhesive transfer process as claimed in claim 2, wherein in S3, the transfer temperature is 180 to 200° C., and the duration time is 15 to 20 minutes.

10. The vacuum wood grain transfer process for height-adjustable tables as claimed in claim 3, wherein in S4, the transfer temperature is typically 180 to 200° C., and the duration time is 15 to 20 minutes.
